(19) United States
(12) Patent Application Publication
(10) Pub. No.: US 2005/0256985 A1
(43) Pub. Date: Nov. 17, 2005

(54) Sending progress information of other users for transmitted shared content

(75) Inventor: Matthew T. Shea, Bellevue, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: WildTangent, Inc.

(21) Appl. No.: 11/128,616

(22) Filed: May 12, 2005

Related U.S. Application Data
(60) Provisional application No. 60/570,932, filed on May 13, 2004.

(51) Int. Cl. G06F 13/00

(52) U.S. Cl. 710/108

(57) ABSTRACT

Participants are notified of the loading progress or consumption of shared content by other participants. Participants generate progress information that is broadcast or sent to other participants. Progress information may be reported according to a designated time frequency and/or progress frequency. Connections established early in the loading process between the participants convey progress information to each participant. Depending on network topology, progress information may be sent via a server or peer to peer. By communicating the expected waiting time or completion time of other users, participation by a specific user in the multi-user application may increase accordingly.

### CROSS-REFERENCES TO RELATED APPLICATIONS

This application claims the benefit of U.S. Provisional Application No. 60/570,932 originally filed May 13, 2004, and entitled SHARED LOADING PROCESS under 35 U.S.C. § 119(e).

### FIELD OF THE INVENTION

The present invention relates to the field of electronic data/information processing. More specifically, the present invention relates to methods and devices for notifying a user of the load progress of other companion users in a distributed multi-user session, such as multi-player gaming.

### BACKGROUND

As computing devices become more powerful, more nontraditional network capable computing devices are available. Some examples of nontraditional network capable computing devices include application specific devices, such as set top boxes, entertainment personal digital assistants, pagers, text messengers, smart appliances, and wireless mobile phones. As the adoption of these computing devices has spread, interaction among these computing devices becomes an important design factor for most multi-user programs. Specifically, designers must determine whether traditional network capable computing devices such as mainframes, desktops, laptops, and palm sized computers should allow the nontraditional application specific network capable computing devices to network together using the application being designed.

Various methods of delivering shared content may be used by the application, because the shared content is often delivered at varying rates to the different computing devices. Moreover, when a variety of non-traditional network capable computing devices are included in a shared content application, the devices will often have different load times for the shared content.

One feature of many shared content applications is that the various users should simultaneously or nearly simultaneously view or access the shared content. As a result, the shared content must often be “equally” available to each of the participating devices. As such, the shared content is often loaded onto all of the participating devices before initiating simultaneous access to the shared content.

Loading times may vary depending on a variety of factors including, but not limited to, connection type and type of network capable computing device, such as traditional or nontraditional. Exemplary connection types include, but are not limited to, wireless, local, private, wide area and/or public network connections.

Alternatively, shared content on other multi-user applications may already be available on the network capable computing devices. However, these applications often require coordination of various factors, including the generation and propagation of random events. Exemplary events that may need to be coordinated include, but are not limited to, card order in a card game, die totals for dice, or character placement in character-based games. As such, the time required to synchronize all the participating users in a multi-user environment may also be represented as a load time, or portion thereof. More specifically, the load time may include time required to establish connections with the other users and coordinating future “random” events. Generally, the more diversified the network capable computing devices participating, potentially, the longer the load time required for synchronization.

Together, these and other factors contribute to the diversity of available data delivery options for network capable computing devices. Recently, this diversity often generates an unacceptable disparity between the different load processing times required for participating network capable computing devices in an electronic multi-user gaming environment, thereby resulting in a high drop-off rate, and user dissatisfaction.

### BRIEF DECRIPTION OF THE DRAWINGS

The present invention will be described by way of exemplary embodiment but not limitations, illustrated in the accompanying drawings in which like references to note similar elements, and in which:

FIG. 1 illustrates a system view of an exemplary operating environment suitable for use to practice the present invention, in accordance with one embodiment.

FIG. 2 illustrates an architectural view with enlarged displays suitable for use as exemplary game loading screens, in accordance with one embodiment.

FIG. 3 illustrates an architectural view of an exemplary peer to peer operating environment suitable for use to practice the present invention, in accordance with one embodiment.

FIG. 4 illustrates an architectural view of an exemplary server based operating environment suitable for use to practice the present invention, in accordance with one embodiment.

FIG. 5 illustrates a flowchart of an exemplary shared content game loading process, in accordance with one embodiment.

FIG. 6 illustrates a flowchart of an exemplary application loading process suitable for use to practice the present invention, in accordance with one embodiment.

FIG. 7 illustrates a flowchart of an exemplary load notification process suitable for use to practice the present invention, in accordance with one embodiment.

### DETAILED DESCRIPTION

In the following detailed description, reference is made to the accompanying drawings which form a part hereof wherein like numerals designate like parts throughout, and in which are shown, by way of illustration, specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

Embodiments of the present invention include a relatively user-friendly technique for indicating the loading progress of shared content for a specific user relative to other users in a multi-user environment, such as a multi-player gaming session between multiple computing devices. For ease of understanding, the description is presented primarily in the context of multi-player gaming. However, embodiments of the present invention are not so limited and may be practiced for other multi-user applications.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment; however, it may. The terms “comprising”, “having”, and “including” should be considered synonymous, unless the context dictates otherwise. Nor should the use of any of these phrases imply or indicate that the particular feature, structure, or characteristic being described is a necessary component for every embodiment for which such a description is included.

In the following description, various aspects of selected embodiments of the present invention will be described. However, it will be apparent to those of ordinary skill in the art and others that alternate embodiments may be practiced with only some of or all of the aspects of the present invention. For purposes of explanation, specific numbers, materials and configurations are set forth in order to provide a thorough understanding of the present invention. However, it will be apparent to those of ordinary skill in the art and others that alternate embodiments may be practiced without the specific details. In other instances, well-known features are omitted or simplified in order not to obscure the illustrated embodiments.

The various operations will be described as multiple discrete steps in turn, in a manner that is most helpful to understanding of the present invention. However, the order of description should not be construed to imply that these operations are necessarily order dependent. In particular, these operations may not be performed in the order of presentation.

A “storage medium” as used herein includes any mechanism that provides (i.e., stores and/or transmits) information in a form readable by a machine (e.g., a computer, digital device). For example, a storage medium includes read only memory (ROM); random access memory (RAM); magnetic disk storage media; optical storage media (e.g., Digital Versatile Disk, Compact Disk); flash memory devices (e.g., USB flash drive, Secure Digital (SD) memory card, Compact Flash (CF) memory card, Smart Media (SM) memory card, Multi Media Card (MMC), MemoryStick (MS) card); electrical, optical, acoustical or other form of propagated signals (e.g., carrier waves, infrared signals, digital signals); etc.

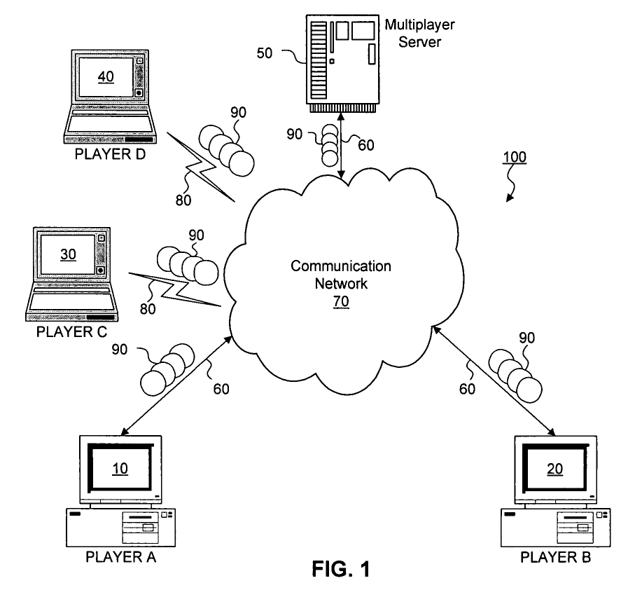

Referring now to FIG. 1, wherein an exemplary operating environment 100 suitable for use to practice teachings of the present invention, in accordance with one embodiment, is shown. The operating environment 100 may also be considered and/or referred to as a system or a cluster of systems. As illustrated, the operating environment 100 includes multiple player devices (10, 20, 30, and 40) and multiplayer server 50 operationally coupled to each other via communication channels 60 and 80 across communication network 70, such as the Internet. Player devices (10, 20, 30, and 40) exchange data 90, including shared content, and potentially including progress information, with multiplayer server 50 via communication network 70. In an alternate embodiment, multiplayer server 50 may comprise multiple blade servers or multiple networked servers. In an alternate embodiment, operating environment 100 may exclude multiplayer server 50, such that data 90 is exchanged between participating player devices (10, 20, 30, and 40). In one embodiment, the data 90 is exchanged directly between each participating player device (10, 20, 30, and 40).

The term “progress information” as used herein refers to information indicative of the progress of one or more operations, which collectively may be referred to as a process. In various embodiments, the process may be a loading process of shared contents onto player devices (10, 20, 30, and 40). The loading may include selective exchange of data between server 50 and player devices (10, 20, 30, and 40), and/or among the player devices (10, 20, 30, and 40), and the data may include random events. The loading process under which the relative progress may be selectively or fully shared among the player devices (10, 20, 30, and 40), for ease of understanding, will be referred to as the “shared loading process”.

Embodiments of the present invention may be used for different types of media. Exemplary media types include audio, video, multimedia, and the like. The various media types may be employed for multiplayer games. In one embodiment, the shared loading process is employed in multiplayer games. Thus, the shared content may also include audio, video, multimedia, and other data. An embodiment of the present invention is relatively more effective in handling media that is streamed “on demand” to the user. The shared content may be streamed to each of the participating users from a distributed or centralized source.

In various embodiments, including the illustrated embodiment, some or all of the player devices (Player C 30 and Player D 40) may be coupled to each other wirelessly, where all or some portion of the communication channel 80 is wireless. As such, the present invention may be practiced in a wireless, wire-based, or mixed wireless and wire-based network. Exemplary communication channels include Ethernet, wireless, coaxial cable, optical cable, and other similar communication channels. In addition to the Internet, other exemplary communication networks include peer to peer networks, wireless networks, private networks, dedicated networks, intranet, or combinations thereof.

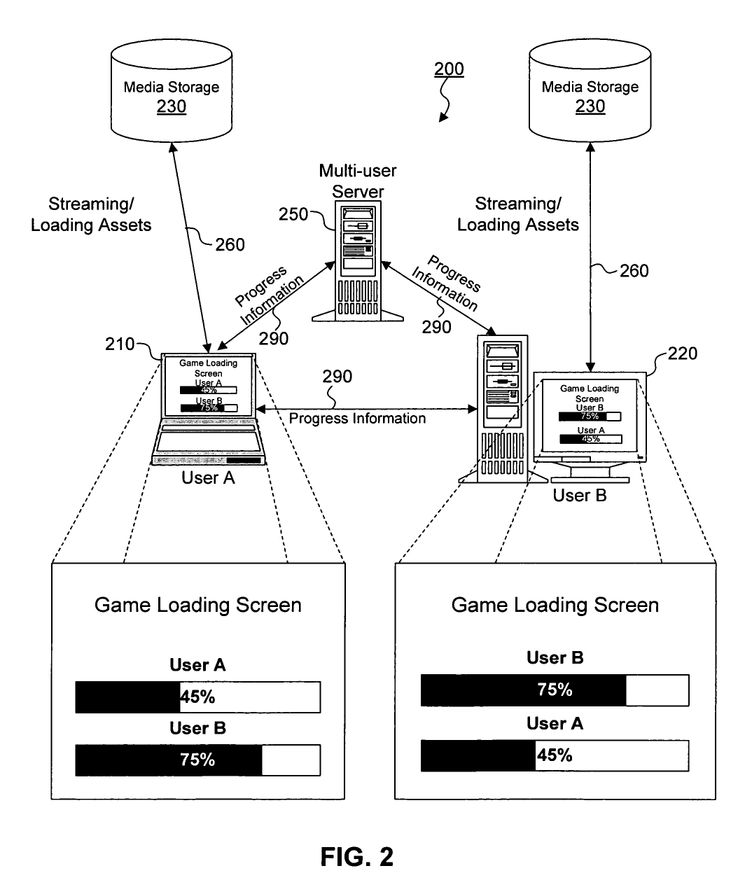

FIG. 2 illustrates a multiplayer game architecture with two player devices, showing exemplary game loading screens suitable for use in an embodiment of the present invention. The illustrated architectural system 200 includes multiple player or user devices 210 and 220 (User A and User B), each having access to media storage 230 containing shared content. The system 200 also includes a multi-user server 250. As the shared content is streaming/loading via data channel 260 to the user devices 210 and 220, progress information 290 is shared between the server 250 and the user devices 210 and 220.

The present invention includes a method by which user devices 210 and 220 participating in a shared experience or piece of content 230 are notified of the loading process of other user devices. In illustrated system 200, the load progress of user devices 210 and 220 are synchronized according to percentage of completion with regard to the task of loading assets for the game. This technique may be used to increase overall user participation by communicating the expected wait time of other users, and reducing the drop off of users before everything is fully loaded. One embodiment establishes a connection for sharing progress information 290 between the user devices 210 and 220 as early in the process as possible and at that time the current loading progress of assets 260 can be broadcast between user devices. Data for the derivation of progress information 290, and Progress information 290 themselves, including status text, loading progress and connectivity information, are exchanged between participating user devices and with the server 250. In various embodiments, the shared content and other assets are exchanged between server 250 and user devices 210 and 220 in packets. The data for derivation of progress information may include acknowledgments of receipts of the data packets by user devices 210 and 220.

Progress information 290 may include load progress identifying when shared content is transmitted or received. Other examples of progress information 290 may include additional status text or information, connectivity information, game content information, user generated content (e.g., text messages sent during the load process to other participants), or relative load progress for each participant. In one embodiment, server 250 determines the relative load progress by comparing the progress information 290 associated data received from each user. The relative load progress may include projected wait time for the loading process to be completed for each participant. The server 250 may then select the longest projected wait time and broadcast this as the anticipated wait time to all the users. Alternatively, the load progress may be based on the size of the remaining shared content to be distributed compared to the anticipated size of the shared content. In an alternate embodiment, system 200 may exclude server 250 and/or the multiple media storage units 230.

For multiplayer games, the progress information 290 could be broadcast via a central server, a peer to peer connection, or a distributed network system. In one embodiment, the method of transmission is based on network topology of the program/game being loaded. Another embodiment provides the broadcast based on the network topology of the participating users.

In one embodiment, the broadcast of loading progress can either be at a given time frequency or a given progress frequency. An exemplary time frequency might be provided every 5 seconds. Whereas an exemplary progress frequency might be provided every 5% of the received load as determined based on the expected size of the loading process. Other exemplary progress frequencies include quantitative progress, such as the percentage of total download expected and/or received, and qualitative progress, such as the effective transfer rate of data being downloaded.

The system 200 indicates that the player devices 210 and 220 can have a connection via a server 250 or peer to peer. The status of the local player and the other participant is displayed on the exemplary game loading screen. The loading of assets from media storage 230 could be from local media storage or streamed over a network. Exemplary local media storage include hard/fixed disk, random access memory (RAM), read only memory (ROM), and the like. Exemplary streaming networks include local area networks (LAN), wide area networks (WAN), the Internet, and the like. In one embodiment, the streaming may be facilitated by a server, such as a Web server, multiplayer server, or the equivalent.

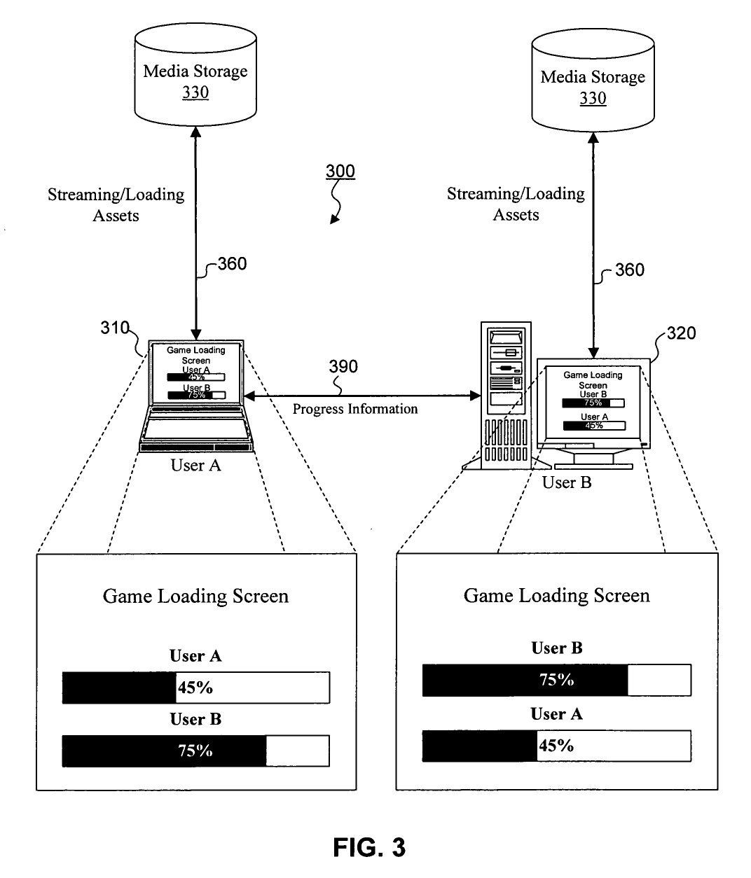

In FIG. 3 illustrates a peer to peer game architecture showing exemplary game loading screens for use in an embodiment of the present invention. System 300, includes user devices 310 and 320, and media storage 330. Player or user devices 310 and 320 of the illustrated system 300 have a peer to peer or direct communication channel to exchange progress information 390. In this manner, each user has access to the other user and respective media storage 330 containing shared content through the communication channel. The media storage 330 could provide the shared content through local media storage or stream the content over a network. Moreover, the loading of shared content from media storage 330 could be different for each user. For example User A may retrieve the shared content from local media storage, while User B may receive streamed content over a network.

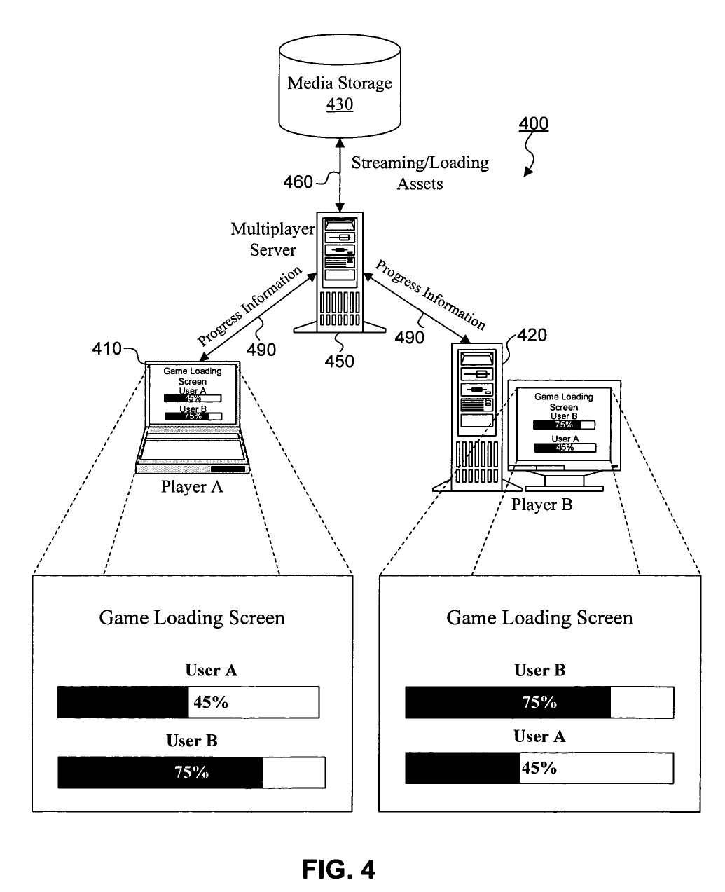

FIG. 4 illustrates a multiplayer game architecture, showing exemplary game loading screens, with players accessing a multiplayer server for shared content according to an embodiment of the present invention. The illustrated system 400 includes multiple player devices 410 and 420 (Player A and Player B), each having access to media storage 430 via multiplayer server 450. The assets from the media storage 430 are streamed or loaded across data channel 460 via the server 450. As the shared content is streaming/loading via data channel 460 to the players 410 and 420, progress information 490 is shared between the individual player devices 410 and 420 and the server 450. In this configuration, system 400 may transmit or send at least a first portion of requested shared content to each participant before receiving progress information. Upon receiving the progress information 470 associated data from the player devices, the server 450 may broadcast the combined progress information with the remaining portions of the requested shared content to the players. In one embodiment, the progress information is broadcast in a data stream separate from shared content stream.

In an alternate embodiment, the server 450 does not receive progress information, but can determine the relative load progress from the amount of data transmitted to each participant. In this way, progress information may be sent to the player without requiring updates from the player devices.

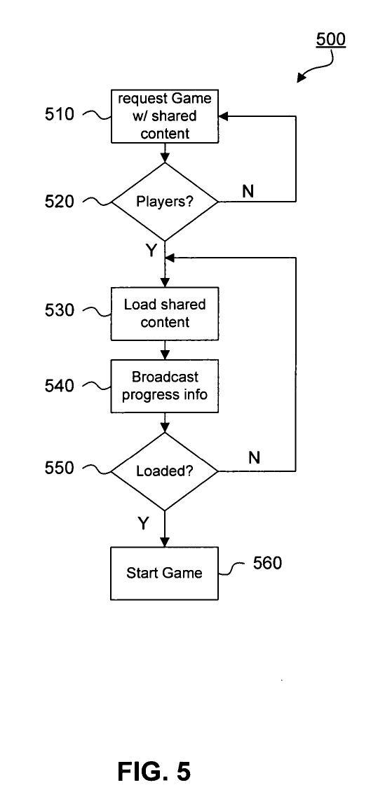

Turning now to FIGS. 5-7, the particular methods of the invention, in accordance with various embodiments, are described in terms of computer software and hardware with reference to a series of flowcharts. The methods to be performed by a network capable computing device constitute state machines or computer programs made up of computer-executable instructions. Describing the methods by reference to a flowchart enables one skilled in the art to develop such programs including instructions to carry out the methods on suitably configured network capable computing devices (the processor of the device executing the instructions from computer-accessible media).

The computer-executable instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language.

Although not limited thereto, computer software programs for implementing the present method may be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java.TM., Jini.TM., C, C++, C#, Perl, UNIX Shell, Visual Basic or Visual Basic Script, Virtual Reality Markup Language (VRML), ColdFusion™ or other compilers, assemblers, interpreters or other computer languages or platforms.

It will be appreciated that a variety of programming languages may be used to implement the teachings of the present invention as described herein. Furthermore, it is common in the art to speak of software, in one form or another (e.g., program, procedure, process, application, etc.), as taking an action or causing a result. Such expressions are merely a shorthand way of saying that execution of the software by a network device causes the processor of the computer to perform an action or a produce a result.

Referring now to FIGS. 5-7, flowcharts are presented which illustrate exemplary operations performed by the present invention in displaying to a user the relative load progress of other users compared to the load progress of the user.

FIG. 5 is a flowchart that illustrates a multiplayer game employing a shared loading system 500 by which player devices participating in a shared piece of content or experience broadcast load progress information to other player devices, in accordance with one embodiment. The shared loading system 500 may be used to increase overall player participation by communicating the expected wait time of other players, and reducing the likelihood of drop off of players before shared game content is fully loaded. Upon receiving or initiating a request to start a multiplayer game in block 510, the system 500 in query 520 determines whether enough players are participating to start the load process. In one embodiment, the system 500 waits until enough players join before starting the loading of the shared content onto the various player devices in block 530. In an alternate embodiment, shared content is loaded to a player device immediately upon request; however, the start of the game in block 560 is delayed until query 520 is satisfied.

One embodiment establishes a connection between the user devices as early in the load process performed in block 530 as possible so that the current loading progress information can be selectively broadcast between user devices in block 540. For multiplayer games, the progress information could be broadcast via a central server, a peer to peer connection, or a distributed network system. In one embodiment, the method of transmission is based on network topology of the program/game being loaded. Another embodiment provides the broadcast based on the network topology of the participating user devices.

In an alternate embodiment, only a portion of the shared content is loaded in block 530 and the progress information associated data including loading progress associated data are exchanged between participating player devices and with the server in block 540. In query 550, the system determines whether the requested assets or shared content have been loaded. If not completely loaded, the system returns to block 530 to continue the load process. Once query 550 indicates that the program or shared content portion is loaded, the system 500 starts the game or shared experience in block 560.

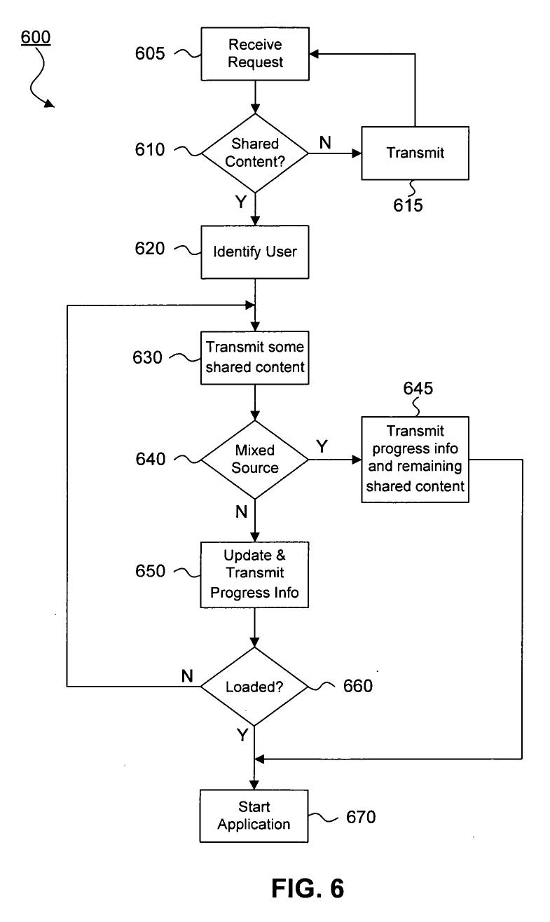

FIG. 6 is a flowchart that illustrates a multi-user application employing a notification system 600 by which users participating in a multi-user application are notified of the loading progress of other users, in accordance with one embodiment. In this way, notification system 600 may increase overall user participation by communicating expected wait time and may reduce a drop off rate of users prior to completing the load process.

Upon receiving a request in block 605, the system 600 determines whether shared content or synchronized assets are associated with the request in query 610. If not, the system 600 allocates the requested resource or transmits the requested data in block 615. If query 610 determines that shared content or synchronized assets are involved, the system 600 identifies the user devices in block 620. Identification of the user devices may help the system 600 to optimize collection and dispersal. In one embodiment, the system 600 may determine the method of transmission based on network topology of the application, program, or game being loaded. Another embodiment will provide the broadcast of progress information based on the network topology of the participating user devices.

Once the user devices are identified and respective resources/capabilities classified in block 620, the system 600 transmits a portion of shared content in block 630 in accordance with the detected identification. In a multi-user environment, the portions of shared content may vary in size and transmission frequency. Query 640 determines whether the user is capable of mixed or bidirectional communication; such that progress information may be sent and received along with the remaining shared content. Accordingly, once the system 600 determines that the user can regulate the download of the remaining shared content then block 645 begins transmission of the remaining shared content and associated reporting of progress information associated data. If the user is not capable of providing the necessary feedback, the system 600 in block 650 must either regulate the distribution of the information to the user and/or provide progress information to the other user devices on behalf of the user device. There are a variety of reasons for the server to remain involved in the load process including available network topology. For example, the user device may only have limited delivery and response capabilities and therefore exhibits diminished communication capability. Query 660 determines whether the system 600 has loaded the shared content. In an alternate embodiment, the determination in query 660 is not whether all of the content is loaded, but whether sufficient content is available to proceed. In block 670, the system 600 starts the application, a piece of content, or a shared experience.

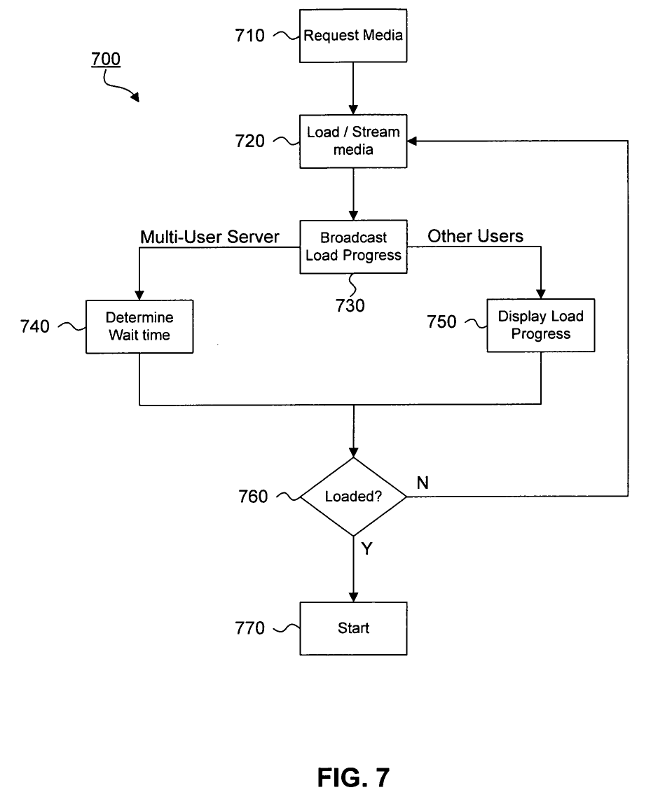

FIG. 7 is a flowchart that illustrates a multi-user load progress system 700 by which user devices participating in a shared piece of content or experience may broadcast load progress information to other user devices, in accordance with one embodiment. The load progress system 700 may be used to increase overall user participation by communicating the expected wait time, and reduce the likelihood of drop-off of players before the system 700 is properly loaded.

Upon receiving or initiating a request for media from media storage in block 710, the system 700 loads/streams media to the user in block 720. Periodically, the system 700 exchanges progress information through a broadcast of load progress in block 730. The broadcast progress information from block 730 assists the multi-user server to determine a wait time in block 740 for all the user devices based on the remaining load and detected load progress. The system 700 provides the other user devices with the broadcast load progress information to be displayed in block 750. The system 700 determines in block 760 whether enough of the load progress has been completed to start the application in block 770. If the load process is not completed, system 700 continues loading/streaming media in block 720.

Although specific embodiments have been illustrated and described herein, it will be appreciated by those of ordinary skill in the art and others, that a wide variety of alternate and/or equivalent implementations may be substituted for the specific embodiment shown in the described without departing from the scope of the present invention. This application is intended to cover any adaptations or variations of the embodiment discussed herein. Therefore, it is manifested and intended that the invention be limited only by the claims and the equivalence thereof.

1. A method comprising:
receiving requests for shared content from at least two participants in a joint consumption of the shared content;
transmitting at least a first portion of the requested shared content to each participant; and
sending to at least one participant progress information associated with the transmitting to at least one other participant, at least once, prior to completion of the transmitting to the at least one other participant.

2. The method as recited in claim 1, wherein the sending comprises sending to each participant progress information associated with the transmitting to each other participant, periodically, prior to completion of the transmitting to each other participant.

3. The method as recited in claim 1, wherein the sending comprises sending progress information including a percentage of the first portion of the shared content received by the at least one other participant.

4. The method as recited in claim 1, wherein the transmitting comprises transmitting the first portion in packets, and the method further comprises receiving data indicative of receipt of the transmitted packets from each participant.

5. The method as recited in claim 1, wherein the receiving comprises correspondingly receiving the requests from the participants.

6. The method as recited in claim 1, wherein the sending comprises sending progress information including a percentage of the first portion of the shared content remaining to be received by the at least one other participant.

7. The method as recited in claim 1, wherein the sending comprises sending progress information including an estimated amount time for remainder of the first portion of the shared content to be transmitted to the at least one other participant.

8. The method as recited in claim 7, wherein the method further comprises selecting the at least one other participant.

9. The method as recited in claim 8, wherein the at least one other participant is a slowest of the participants.

10. The method as recited in claim 1, wherein the sending comprises sending to each participant progress information associated with the transmitting to each other participant, periodically at either predetermined time intervals or completions levels, prior to completion of the transmitting to each other participant.

11. The method as recited in claim 1, wherein the shared content comprises media selected from the group consisting of audio, video, multimedia, and data.

12. The method as recited in claim 11, wherein the shared content is a multi-user online game.

13. A method comprising:
establishing at least one communication channel between players in a multiplayer game after starting a shared loading process;
sending to at least one player progress information associated with at least one other player via the at least one communication channel; and
indicating load progress of the at least one player relative to the at least one other player based in part on the received progress information.

14. The method as recited in claim 13, wherein the sending comprises sending progress information including a percentage of content of the shared loading process remaining to be received by the at least one other player.

15. The method as recited in claim 13, wherein the sending comprises sending progress information including an estimated time for remainder of the shared content to be transmitted to the at least one other player.

16. The method as recited in claim 13, wherein the indicating comprises indicating load progress including progress information based in part on shared content transmitted by a multiplayer server to the players.

17. The method as recited in claim 13, wherein the indicating comprises indicating load progress including progress information based in part on shared content loaded by the at least one player and the at least one other player.

18. The method as recited in claim 13, wherein the sending comprises sending progress information associated with each player to a multiplayer server, the server combining received progress information and transmitting the combined progress information to at least one player, periodically at either predetermined time intervals or completion levels, prior to completion of the shared loading process.

19. The method as recited in claim 13, wherein the indicating comprises displaying the load progress including a graphical representation comparing load progress for a shared loading process of the at least one player to the at least one other player.

20. An apparatus comprising:
storage medium having stored therein programming instructions, when executed upon initiating a load operation for shared content, operate the apparatus to:
create progress information, including load progress for shared content and completion parameters of the load operation,
report progress information relative to the completion parameters and load progress, and
receive and display progress information from other participants; and
a processor coupled to the storage medium to execute the programming instructions.

21. The apparatus of claim 20, wherein said programming instructions, when executed, operate the apparatus to report load progress for shared content.

22. The apparatus of claim 20, wherein said progress information includes load progress, status information, connectivity information, game content, and user content information.

23. The apparatus of claim 20, wherein said progress information includes instant message information from the user to invite other users to join.

24. The apparatus of claim 23, wherein said other users dynamically stream unloaded data assets upon acceptance of the invitation extended by the user.

25. A system comprising:
media storage having shared content for use in a multiplayer network game; and
multiple players, each player being in communication with the other players, each player selectively transmitting progress information via a communication network and notifying other players of each player's loading progress.

26. The system of claim 25, further comprises a multiplayer server in communication with the players via said communication network, the multiplayer server relaying progress information to the multiple players.

27. The system of claim 25, wherein the progress information is broadcast according to a given time frequency.

28. The system of claim 25, wherein the progress information is broadcast according to a given progress frequency.

29. The system of claim 25, wherein each player displays the status of the local player and the other players.

30. The system of claim 25, wherein the media storage is selected from the group consisting of local media and streamed media.
